(19) United States
(12) Patent Application Publication
(10) Pub. No.: US 2012/0242051 A1
(43) Pub. Date: Sep. 27, 2012

(54) ROLL-OFF BIN EQUIPPED WITH WHEELS

(76) Inventor: Marcel A. LACASSE, Ottawa (CA)

(21) Appl. No.: 13/364,908

(22) Filed: Feb. 2, 2012

(30) Foreign Application Priority Data
Mar. 24, 2011 (CA) 2735074

(51) Int. Cl. B65F 3/26

(52) U.S. Cl. 280/29

(57) ABSTRACT

The present invention discloses a roll-off bin equipped with a set of wheels mounted near the rear section of the bin. The wheels consist of pneumatic or dense foam filled rubber tires mounted on steel rims. The wheels are custom mounted on axles of proper gross axle weight rating for the bin's size. When the bin is being unloaded to the ground from a roll-off truck, the wheels make first contact with the ground, thereby minimizing potential damages to the landing surface. The roll-off bin is also equipped with a set of mechanical or hydraulic jacks, mounted at or near the front section of the bin. With the assistance of a roll-off lifting equipment, the jacks provide a means of leveling the bin in its final position on the ground surface.

### BACKGROUND OF THE INVENTION

1. Field of the Invention

This invention relates to a roll-off bin equipped with wheels on the rear section for soft landing on the ground when the bin is being loaded and unloaded to and from a dumpster truck, respectively.

2. Prior Art Description

The use of roll-off bins in the recycling and demolition industry has been in existence for many years. Roll-off bins currently used in the market are typically made of metal and consist basically of familiar, standard structural shapes. There are a few varieties of designs to fulfill specific objectives and requirements. For example, rectangular, V-shape bottom and lugger bins. When these bins are unloaded from a dumpster truck, the metallic nature of these bins often damages the landing surface, such as paved asphalt or interlock-stone driveways. Similar damages occur when the bins are loaded back onto the dumpster truck. Current bin and container technologies have failed to address this problem with the conventional metal rollers. A common practice adopted over the years to prevent such damage has been to roil the bin on wooden planks, but this operation has always been impractical and challenging to the truck operator, especially when loading a bin that is full. The larger 20 to 40 cubic yard bins, popular in the recycling and demolition industry, can easily attain gross weights of up to 20-25 tons. Thus, even with the aid of rigid resting pads, these bins still damage driveways when they are being dropped or dragged in position by the roll-off equipment.

Hitherto, wheels are typically provided on trailers or carts. By way of example, U.S. Pat. No. 6,318,808 to Shayne teaches a lawn tractor/dump pull cart system with a supplemental wheel set assembly to enhance the safety, utility and convenience of lawn carts coupleable to riding lawn mowers for towing, dumping and spreading. U.S. Pat. Application Publication No. US 2009/0194968 to Ardagna discloses a utility trailer pulled by a tow vehicle utilizing a two point coupling to the tow vehicle and a swiveling axle assembly to create a three point “landing gear” for easy installation onto the tow vehicle.

While these devices fulfill their respective, particular objectives and requirements, the aforementioned disclosures do not describe a wheeled mechanism adopted for industrial roll-off bins objected to alleviate damages resulting from loading and uploading of such bins from dumpster trucks. Thus, there exists a practical and long felt need for a new roll-off bin design equipped with a set of custom mounted wheels which can be used without causing damage to the bin-receiving ground. In this regard, the present invention substantially fulfills this need.

### SUMMARY OF THE INVENTION

In view of the foregoing disadvantages inherent in the roll-off bins currently available in the market which are confined to known designs and configurations, the present invention provides an improved roll-off bin equipped with a set of wheels mounted on the rear section of the bin. As such, the general purpose of the present invention, which will be described subsequently in greater detail, is to provide a new and improved roll-off bin with wheels which has all the advantages of the prior art and none of the disadvantages.

To attain this, the present invention essentially comprises retrofitting a conventional roll-off bin with custom mounted wheels, and adjustable jacks to facilitate ease and safe loading and uploading from a roll-off truck without damaging the surface where it is being dropped in position, or during the lifting process when the bin is full. The invention provides a roll-off bin with wheels which are equipped with either pneumatic or dense foam rubber tires.

There has thus been outlined, rather broadly, the more important features of the invention in order that the detailed description thereof that follows may be better understood and in order that the present contribution to the art may be better appreciated. There are, of course, additional features of the invention that will be described hereinafter and which will form the subject matter of the claims attached.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved roll-off bin system which comprises, in combination: a set of custom mounted wheels provided near the rear section of the bin; and a set of adjustable jacks and legs provided near the front section of the bin; wherein the roll-off bin is constructed in a blended “U-” and “V-” shaped configuration, as well as other narrower bins suitable to provide clearance and allowance for the wheels.

This object of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a schematic side view of the roll-off bin showing a preferred embodiment of the instant invention.

FIG. 2 is a schematic side view of the roll-off bin of the instant invention loaded on a roll-off truck for suitable transportation thereof.

FIG. 3 is a schematic side view of the roll-off bin being loaded or unloaded to and from a hook-lift roll-off truck respectively.

FIG. 4 is a schematic side view of the roll-off bin being loaded or unloaded to and from a hoist roll-off truck respectively.

FIG. 5 is a schematic perspective front and side views of the roll-off bin.

FIG. 6 is an enlarged schematic exploded view showing a mechanical jack provided at the front section of the roll-off bin.

FIG. 7 is a schematic rear view of the roll-off bin.

FIG. 8 is a schematic exploded rear view of the roll-off bin showing separate wheel axle mounts.

FIG. 9 is a schematic exploded rear view of the roll-off bin showing a single wheel axle tubular mount.

FIG. 10 is an enlarged schematic rear view showing the axle construction with a single wheel axle tubular mount.

FIG. 11 is an enlarged schematic side view showing the axle construction with a single wheel axle tubular mount.

FIG. 12 is an enlarged schematic side view showing the axle construction with a tandem wheel axle tubular mount assembly.

For the purpose of this disclosure, the expression “front section” or “proximal section” of a roll-off bin refers to that section closest to the cab of the dumpster truck and the expression “rear section” or “distal section” refers to that section farthest away from the truck cab.

In addition, “roll-off bin” as used in the present disclosure is a collective term for refuse container, a skip, a roll-off container, or a dumpster used the industry. Likewise, “dumpster trucks” is a general term for trucks equipped with standard hook-lift or hoist roll-off equipment.

### DETAILED DESCRIPTION OF THE INVENTION

In general, the roll-off bins in accordance with the present invention are manufactured of metal, preferably steel and comprised of three side walls and a back or rear tailgate. The roll-off bins have no top and their capacity ranges from 5 to 40 cubic yards. Typically, the roll-off bins are designed for outside use to service the construction, renovation, demolition, recycling, and waste or refuse removal industries.

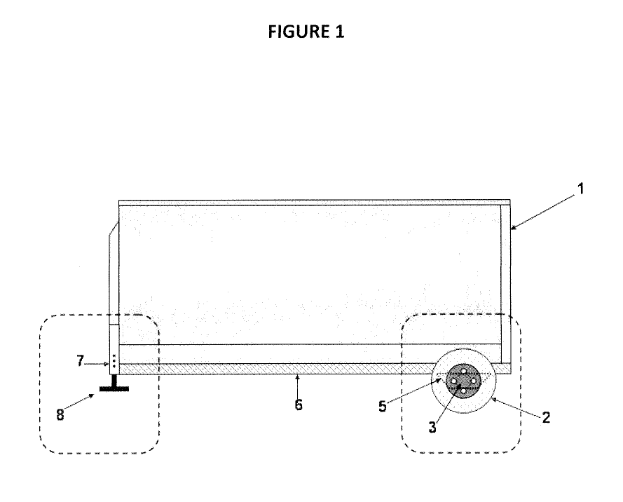

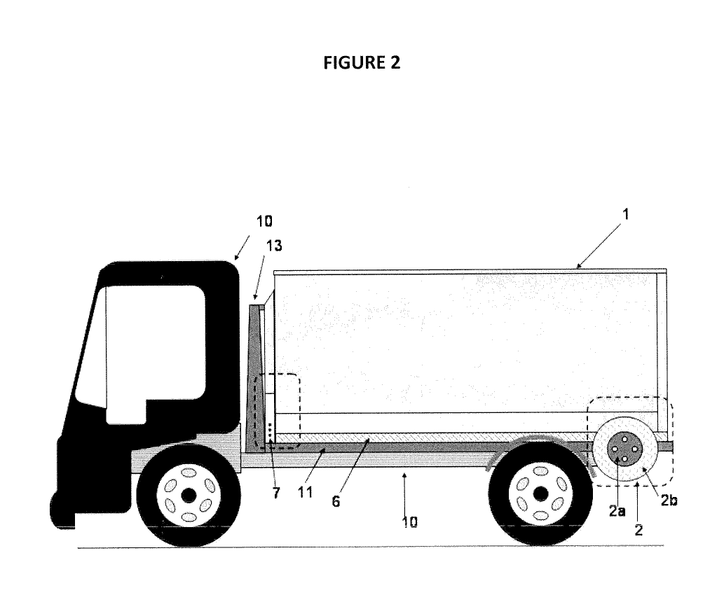

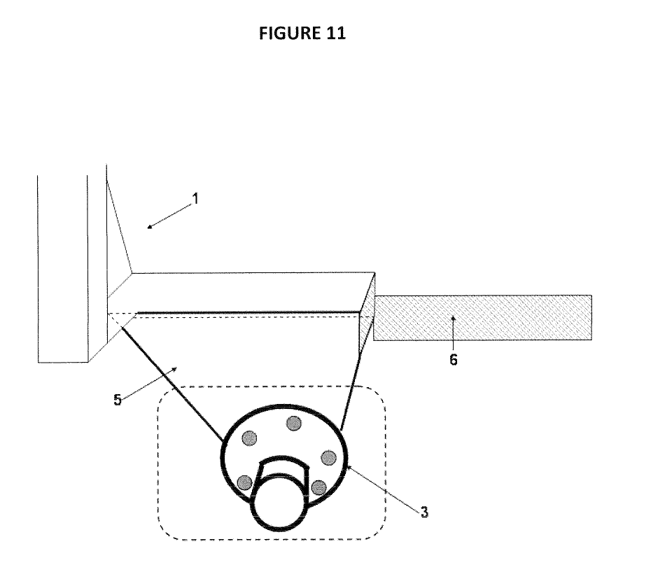

Reference is now made to drawings FIG. 1 and FIG. 2. FIG. 1 shows a schematic side view of the roll-off bin 1 of the present invention, with the front or proximal section facing the left and the rear or distal section facing the right. Roll-off bin 1 is provided with a set of wheels 2, mounted on each side near the rear section of the bin 1. The wheels 2 are custom mounted on axles (not shown) of proper gross axle weight rating for the bin's size. Each wheel 2 consists of a steel rim 2a, pneumatic or dense foam filled rubber tire 2b, with a total diameter suitable for such application. Preferably, the total diameter is at least 12 inches. Wheel 2 is custom mounted on a wheel hub and bearing assembly 3 which is, in turn, mounted to a hub housing and axle 4 (not shown). The hub housing and axle 4 is welded to metal mounting brackets 5. The metal mounting brackets 5 are welded to the bin sub-frame 6. FIG. 11 below provides more detailed description of the wheel 2 and axle construction.

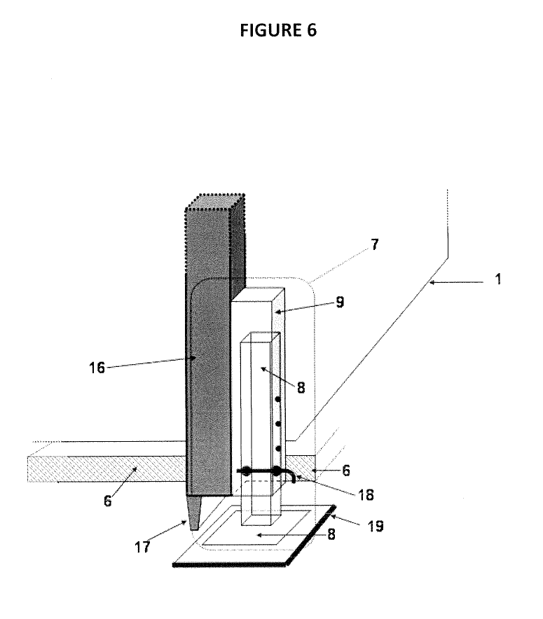

Located at or near the front or proximal section of the bin 1 is a pair or a set of mechanical or hydraulic jacks 7. With the assistance of the roll-off lifting equipment, jack 7, through operation of the adjustable legs 8, provide a suitable means of leveling bin 1 in final position when loaded on the ground surface. FIG. 6 below provides more detailed description of the mechanical or hydraulic jacks 7.

FIG. 2 shows a schematic side view of the roll-off bin 1 sitting securely on the bin sub-frame 6 of a conventional roll-off truck 10 equipped with a hoist 13.

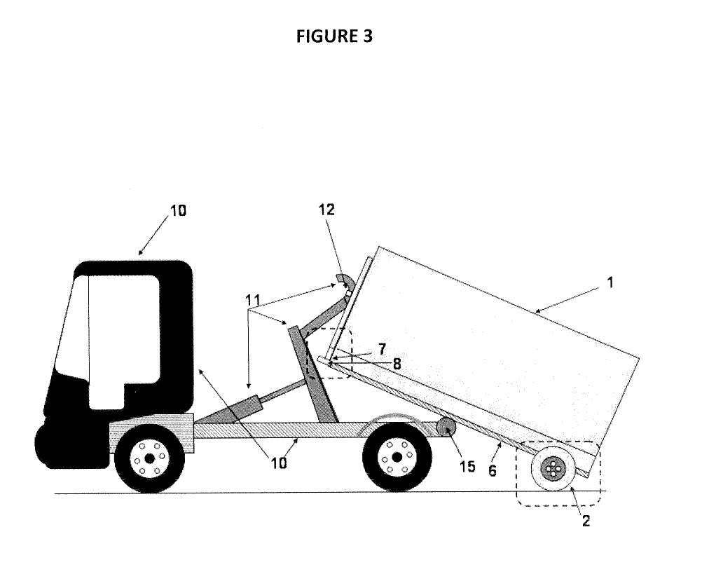

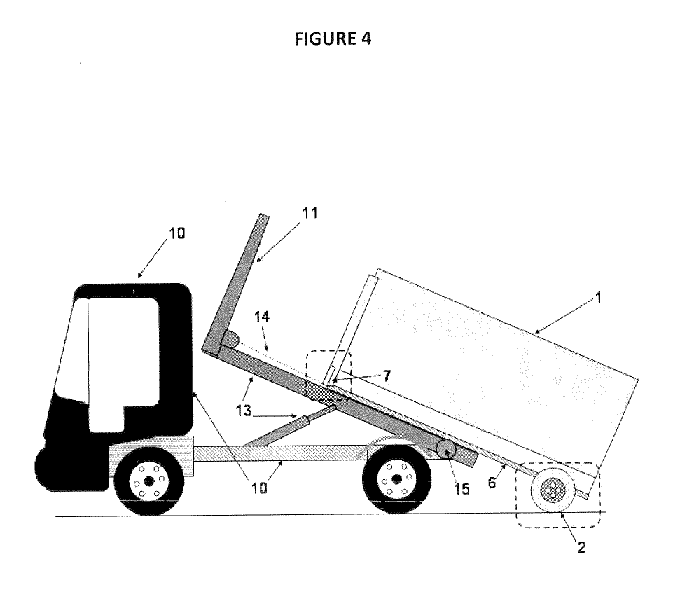

Referring to FIGS. 3 and 4 which show the schematic side view of the roll-off bin 1 of the present invention being loaded or uploaded from the dumpster truck 10. In FIG. 3, the hook-lift mechanism 11 is attached to the hook receptacle 12 of the roll-off bin 1. The hydraulic action of the hook-lift mechanism 11 either extends or retracts, and raises or lowers, thereby rendering the loading or uploading the bin possible. When loading the bin 1 from a “sitting” position to the ground (as shown in FIG. 2), the hydraulic pump of the hook-lift mechanism 11 extends and raises the hook and pushes bin 1 rearward. A roller bar 15 is provided to facilitate the rolling action of the bin 1.

In FIG. 4, the hoist roll-off mechanism 13 releases or pulls the roll-off bin 1 by a roll-off hoist cable 14. The hydraulic action of the hoist roll-off mechanism 13 either extends or retracts, thereby rendering the loading or uploading the bin possible. When loading the bin 1 from a “sitting” position to the ground (as shown in FIG. 2), the hydraulic pump of the hoist roll-off mechanism 13 extends and pushes the mechanism up to a suitable angle for the roll-off hoist cable 14 to conveniently releases the bin 1 rearward and lowering the bin 1 downward. Once again, a roller bar 15 provided to facilitate the rolling action of the bin 1.

The full advantage of the present invention can be seen in FIGS. 3 and 4, in that the wheels 2 of the bin 1 make first contact with the ground surface, thus minimizing any damage to the landing surface despite the heavy impact of the weight of the bin 1. As can be seen from FIG. 6, once bin 1 has been safely rolled to resting position, the adjustable legs 8 work in cooperation with the landing surface protective rubber mat 19 to allow the bin to rest evenly on the landing surface. The hook-lift or roll-off hoist equipment is then released from bin 1, thus completing the loading operation.

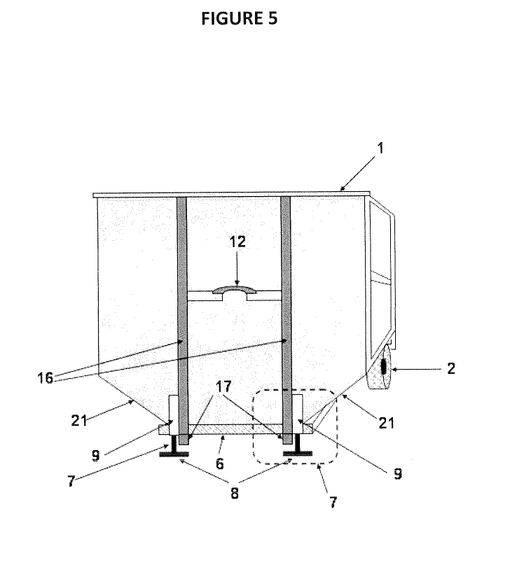

FIG. 5 shows a schematic perspective front and side views of the roll-off bin 1 equipped with a hook receptacle 12 for accepting a hook-lift equipment 11 of the dumpster truck 10. The hook receptacle 12 is mounted in between the front frame tubular channels 16 for hook-lift application. The channels 16 are configured in standard width which corresponds to the roll-off guide rails 17 for both hook-lift and hoist roll-off applications. The bottom bin roll-off guide rails 17 are typically welded to the bin's sub-frame 6.

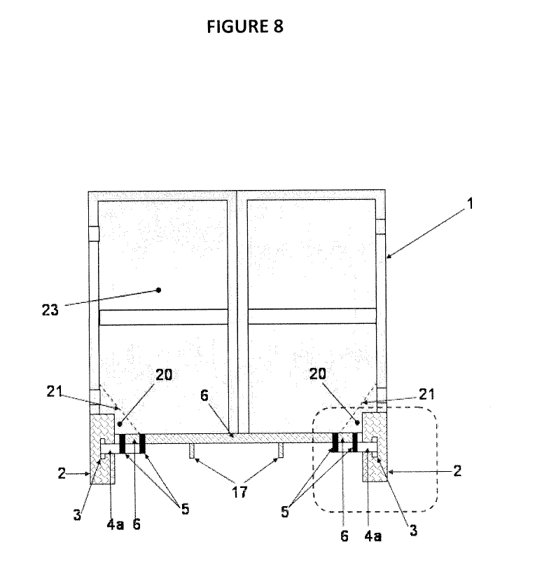

In order for the wheel well 20 (not shown) to house wheel 2 and to enable wheel 2 to operate properly without coming into contact with the sidewall of bin 1, bin 1 needs to be constructed or configured in such a way as to provide adequate and sufficient allowance and clearance for the wheel well 20. The preferred embodiment of the present invention provides a bin 1 with blended “U-” and “V-” shaped configuration, which results in the creation of a slanted side wall 21 (see FIG. 8). In another embodiment (not shown), the dimensions of the bin provide suitable allowance and clearance for the wheel well 20. An example of such a bin takes a narrower square or rectangular configuration.

In addition, the configuration of the bin of the present invention is constructed to comply with the local highway traffic legislations with respect to the width restrictions limits and weight and safety regulations specific to the locality where said bin is being used.

As can be seen from FIG. 5, roll-off bin 1 is equipped with a pair or a set of mechanical or hydraulic legs 8. The jack housing 9 is welded to front frame tubular channel 16, and houses the mechanical or hydraulic jack legs 8. When working in cooperation with the assistance of the roll-off lifting equipment, it provides an effective means for leveling bin 1 in a final resting position on the ground surface. FIG. 6 below provides more detailed description of the mechanical jack 7 and its components.

Reference is now made to FIG. 6, which shows an enlarged schematic exploded view of the mechanical jack 7 provided at or near the front section of the roll-off bin 1. Prior to the dumpster truck 10 detaching the roll-off bin 1 on the landing surface, the mechanical jack 7 is lowered from the inside of the mechanical jack housing 9 by adjusting the jack 7 and leg 8 and locking them in place at the leveled height by means of the holding pin 18. Added protection to the ground surface may be provided by resting the jack leg 8 on a driveway surface protective rubber mat 19, or wooden pad.

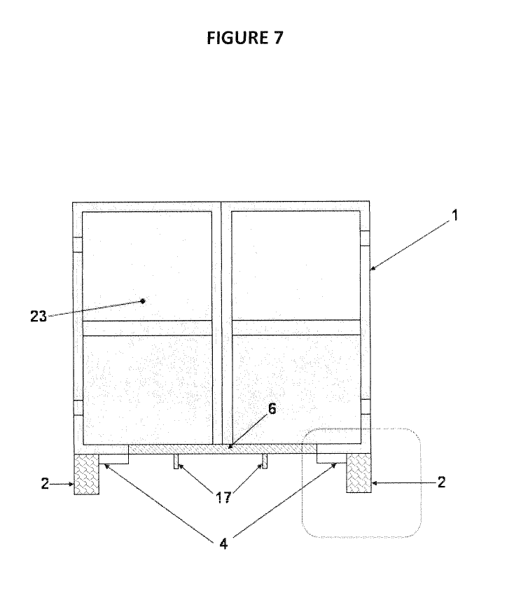

Referring now to FIG. 7, a tailgate 23 is provided at the rear of the roll-off bin 1. The tailgate 23 can be of the same configuration as the bin 1, i.e., substantially blended “U-” and “V-” shape, or is of rectangular shape, as shown in the drawing. Wheels 2 are operatively mounted to the hub assembly housing and axle 4.

FIG. 8 provides a schematic exploded rear view of the bin 1 equipped with separate wheel axle mounts. Each wheel 2 is custom mounted on a separate wheel hub and bearing assembly 3 which, in turn, is separately mounted to a hub housing and axle 4a. Each hub housing and axle 4a is welded to a metal mounting bracket 5. Each metal mounting bracket 5 is welded to the bin sub-frame 6. A slanted side wall 21 is configured to provide the required clearance allowance for wheel well 20. FIG. 11 below provides more detailed description of the wheel 2 and axle construction.

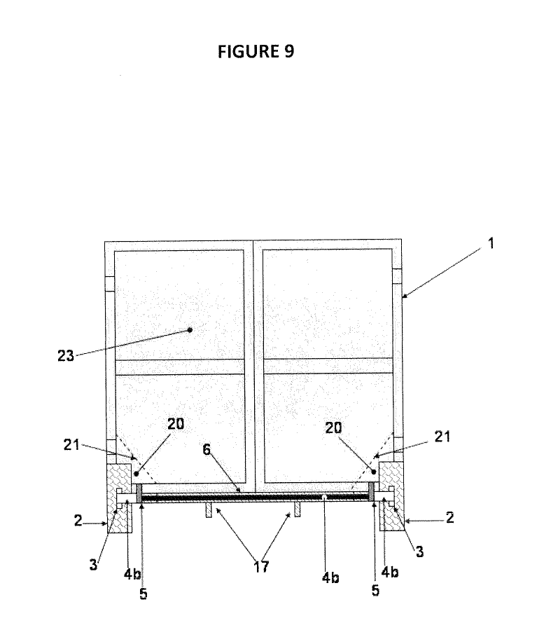

FIG. 9 provides a schematic exploded rear view of the bin 1 equipped with a single wheel axle tubular mount. Wheels 2 are custom mounted on a wheel hub and bearing assembly 3 which, in turn, is mounted to a common single hub assembly housing and single tubular axle 4b of suitable and proper gross axle weight rating for the bin's size. The common single hub assembly housing and single tubular axle 4b is welded to metal mounting brackets 5 provided on each side. The metal mounting brackets 5 are welded to the bin sub frame 6. As in the embodiment shown in FIG. 8, a slanted side wall 21 is configured to provide the required clearance allowance for wheel well 20. FIG. 11 below provides more detailed description of the wheel 2 and axle construction.

In accordance with the present invention, the axle construction can be either configured with a single wheel axle tubular mount or a tandem wheels axle tubular mount assembly.

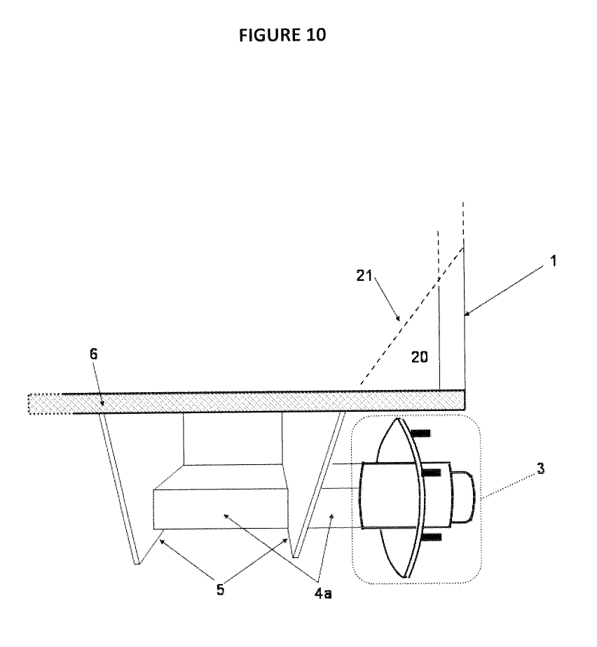

FIG. 10 and FIG. 11 show, respectively, enlarged schematic rear and side views of the axle construction with a single wheel axle tubular mount.

In FIG. 10, which shows one side of the wheel hub and bearing assembly 3, a wheel well 20 is provided below the slanted side wall 21, whereby the wheel hub and bearing assembly 3 is mounted to a hub housing and axle 4a. The hub housing and axle 4a is welded to a metal mounting bracket 5. Each metal mounting bracket 5 is welded to the bin sub-frame 6.

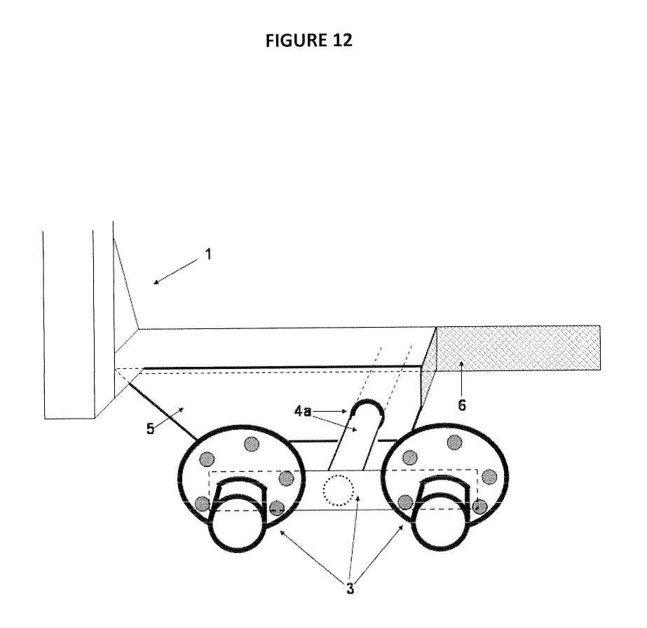

FIG. 12 shows an enlarged side schematic view of the embodiment which provides the axle construction with a tandem wheels axle tubular mount assembly. In this embodiment, roll-off bin 1 is equipped with a tandem set of wheels 22 (not shown). Again, in order to provide proper wheel width and clearances with the bin 1 side walls, the bin 1 is constructed or configured in such way that there is sufficient allowance for a wheel well. Thus, the tandem wheel hub and bearing and mounting frame assembly and the single or separate hub assembly housing and axle and bushing are strategically positioned under the slanted side wall of the bin 1 to provide the required clearance and allowance.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The embodiments of the invention in which an exclusive property or privilege is claimed are defined as follows:

1. A roll-off bin system comprising, in combination:
a set of wheels provided near the rear section of said bin; and
a set of adjustable jacks and legs provided near the front section of said bin;
wherein said bin is constructed in a blended “U-” and “V-” shaped configuration to provide clearance and allowance for said set of wheels.

2. The roll-off bin system of claim 1, wherein said bin is narrow in configuration to provide clearance and allowance for said set of wheels.

3. The roll-off bin system of claim 1, wherein said set of wheels are equipped with either pneumatic or dense foam rubber tires.

4. The roll-off bin system of claim 1, wherein said tires have diameter of at least 12 inches.

5. The roll-off bin system of claim 1, wherein one wheel is provided on each side of said bin.

6. The roll-off bin system of claim 1, wherein each of said wheels is mounted to a separate hub assembly housing axle.

7. The roll-off bin system of claim 1, wherein said wheels are mounted to a common single hub assembly housing axle.

8. The roll-off bin system of claim 1, wherein said bin is provided with one pair of wheels.

9. The roll-off bin system of claim 1, wherein said bin is provided with wheels in tandem.

10. The roll-off bin system of claim 1, wherein the adjustable jacks and legs are operated mechanically.

11. The roll-off bin system of claim 1, wherein the adjustable jacks and legs are operated hydraulically.

12. The roll-off bin system of claim 1, wherein one jack and leg is provided on each side of said bin.

13. The roll-off bin system of claim 1, wherein said bin is adoptable to be loaded and unloaded by a conventional roll-off truck.

14. The roll-off bin system of claim 13, wherein said conventional roll-off truck is dumpster truck outfitted with either hook-lift equipment or roll-off hoist and cable equipment.

15. The roll-off bin system of claim 1, wherein the configuration of said bin is constructed to comply with the local highway traffic legislations with respect to the width restrictions limits and weight and safety regulations specific to the locality where said bin is being used.
